(19) United States
(12) Patent Application Publication
(10) Pub. No.: US 2021/0260925 A1
(43) Pub. Date: Aug. 26, 2021

(54) Pneumatic Tire with Optimized Crown-and-Tread-Pattern Architecture

(71) Applicant: COMPAGNIE GENERALE DES ETABLISSEMENTS MICHELIN, Clermont-Ferrand (FR)

(72) Inventors: François-Xavier BRUNEAU, Clermont-Ferrand Cedex 9 (FR); Mathieu ALBOUY, Clermont-Ferrand Cedex 9 (FR); Daniel FABING, Clermont-Ferrand Cedex 9 (FR); Patrice FRAYSSE, Clermont-Ferrand Cedex 9 (FR); Vincent TOURNEUX, Clermont-Ferrand Cedex 9 (FR)

(21) Appl. No.: 17/255,246

(22) PCT Filed: May 22, 2019
(86) PCT No.: PCT/FR2019/051165

§ 371 Date: Dec. 22, 2020

(30) Foreign Application Priority Data
Jun. 25, 2018 (FR) 1855632

(51) Int. Cl. B60C 9/28; B60C 11/13; B60C 9/00; B60C 11/24

(52) U.S. Cl. CPC B60C 9/28; B60C 11/13; B60C 2009/2064; B60C 11/24; B60C 2200/04; B60C 9/0042

(57) ABSTRACT

The invention is a tire comprising a crown comprising at least one layer of reinforcing elements. The radially outermost layer comprises at least one undulation (512). The undulations (512) in the radially outermost layer (5) are such that the points of the undulations are radially on the outside of the points of said layer (5) that are vertically beneath the centre of the bottom face (243) of the closest major groove (24) by at least a radial distance of 1.5 mm. The undulations (512) in the radially outermost crown layer make up at least 10% of the radially outer surface (ROS) of said crown layer (5). A rubber compound with a dynamic modulus G*, measured at 40° C. at 10% peak-to-peak strain at 10 Hz, that is at most equal to 3.25 MPa, makes up at least 30% of the rubber compounds vertically above said undulations.

### FIELD OF THE INVENTION

The present invention relates to a tire intended to be fitted to a passenger vehicle, and more particularly to the crown of such a tire.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The median circumferential plane referred to as the equatorial plane divides the tire into two substantially symmetrical half-torus shapes, it being possible for the tire to exhibit tread or architecture asymmetries that are connected with the manufacturing precision or with the sizing.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer that is radially on the inside of the crown and connects the two beads.

The tread of a tire is delimited, in the radial direction, by two circumferential surfaces, the radially outermost of which is the tread surface and the radially innermost of which is referred to as the tread pattern bottom surface. The tread pattern bottom surface, or bottom surface, is defined as being the surface of the tread surface translated radially towards the inside by a radial distance equal to the tread pattern depth. It is commonplace for this depth to be degressive over the axially outermost circumferential portions, referred to as the shoulders, of the tread.

In addition, the tread of a tire is delimited, in the axial direction, by two lateral surfaces. The tread is also made up of one or more rubber compounds. The expression “rubber compound” denotes a composition of rubber comprising at least an elastomer and a filler.

The crown comprises at least one crown reinforcement radially on the inside of the tread. The crown reinforcement comprises at least one working reinforcement comprising at least one working layer made up of mutually parallel reinforcing elements that form an angle of between 15° and 50° with the circumferential direction. The crown reinforcement may also comprise a hoop reinforcement comprising at least one hooping layer made up of reinforcing elements that form an angle of between 0° and 10° with the circumferential direction, the hoop reinforcement usually, although not necessarily, being radially on the outside of the working layers.

For any layer of reinforcing elements of a crown, working or other reinforcement, a continuous surface, referred to as the radially outer surface (ROS) of said layer, passes through the radially outermost point of each reinforcing element, of each meridian. For any layer of reinforcing elements of a crown, working or other reinforcement, a continuous surface, referred to as the radially inner surface (RIS) of said layer, passes through the radially innermost points of each reinforcing element, of each meridian. The radial distances between a layer of reinforcing elements and any other point are measured from one or the other of these surfaces and in such a way as not to incorporate the radial thickness of said layer. If the other measurement point is radially on the outside of the layer of reinforcing elements, the radial distance is measured from the radially outer surface ROS to this point, and, respectively, from the radially inner surface RIS to the other measurement point if the latter is radially on the inside of the layer of reinforcing elements. This makes it possible to consider radial distances that are coherent from one meridian to the other, without it being necessary to take into account possible local variations associated with the shapes of the sections of the reinforcing elements of the layers.

In order to obtain good grip on wet ground, cuts are made in the tread. A cut denotes either a well, or a groove, or a sipe, or a circumferential furrow, and forms a space opening onto the tread surface.

A sipe or a groove has, on the tread surface, two characteristic main dimensions: a width W and a length Lo, such that the length Lo is at least equal to twice the width W. A sipe or a groove is therefore delimited by at least two main lateral faces that determine its length Lo and are connected by a bottom face, the two main lateral faces being spaced apart from one another by a non-zero distance referred to as the width W of the sipe or of the groove.

The depth of the cut is the maximum radial distance between the tread surface and the bottom of the cut. The maximum value for the depths of the cuts is referred to as the tread pattern depth D.

A groove is referred to as a major groove if its width W is at least equal to 1 mm and its depth D is at least equal to 4 mm.

In the following text, the expression “vertically beneath” means “for each meridian, radially on the inside within the boundaries of the axial coordinates delimited by”. Thus, “the points of a working layer that are vertically beneath a groove” denote, for each meridian, the collection of points in the working layer that are radially on the inside of the groove within the boundaries of the axial coordinates delimited by the groove.

In the following text, the expression “vertically above” means “for each meridian, radially on the outside within the boundaries of the axial coordinates delimited by”. Thus, “the part of the tread vertically above an undulation” denotes, for each meridian, the collection of points of the tread that are radially on the outside of the undulation within the boundaries of the axial coordinates delimited by the undulation.

### PRIOR ART

A tire needs to meet numerous performance criteria relating to phenomena such as wear, grip on various types of ground, rolling resistance and dynamic behaviour. These performance criteria sometimes lead to solutions that compromise other criteria. Thus, for good grip performance on dry ground, the rubber compound of the tread needs to be dissipative and soft. In contrast, in order to obtain a tire that performs well in terms of behaviour, in particular in terms of dynamic response to transverse loading of the vehicle and therefore loading mainly along the axis of rotation of the tire, the tire needs to have a sufficiently high level of stiffness, in particular under transverse loading. For a given size, the stiffness of the tire depends on the stiffness of the various elements of the tire that are the tread, the crown reinforcement, the sidewalls and the beads. The tread is traditionally stiffened either by stiffening the rubber compounds, leading to a loss of grip on dry ground, or by reducing the depth of the tread pattern or by reducing the groove-to-rubber ratio of the tread pattern, leading to a loss of grip on wet ground.

In order to alleviate the problem, tire manufacturers have, for example, changed the rubber compound by stiffening it notably by way of fibres, as mentioned in the documents FR 3 014 442 and FR 2 984 230.

These solutions are not always satisfactory. Reducing the tread pattern depth limits the performance in terms of wear and in terms of wet grip. Stiffening the rubber compound limits the wet and dry grip capabilities and also increases the tire noise during running. Reducing the void volume of the tread pattern reduces the grip capabilities on wet ground and more particularly when there is a great depth of standing water. It is also important to maintain a certain thickness of rubber compounds between the bottom face of the cuts, grooves or furrows and the reinforcing elements of the radially outermost crown layer, in order to ensure the endurance of the tire.

Thus, the use of certain rubber compounds that are very soft and exhibit a high level of grip to make all or part of the tread is not feasible without impairing the other performance aspects.

### SUMMARY OF THE INVENTION

The main objective of the present invention is therefore to improve performance using tread rubber compounds that are “soft” or exhibit a low level of stiffness, in order to be able to make use of the associated properties thereof. These rubber compounds may, for example, be very hysteretic in order to enhance the dry grip performance or, by contrast, have very low hysteresis to facilitate flattening in order to further improve rolling resistance. In order not to have a negative effect on other performance aspects such as wear or behaviour, these low-stiffness rubber compounds could be disposed over the entire tread or over a limited part thereof. This objective has been achieved without modifying the performance thereof in terms of wear and crown endurance, while complying with the national standards on rolling resistance.

This objective has been achieved by a passenger vehicle tire comprising:
a tread intended to come into contact with the ground via a tread surface comprising grooves, a groove forming a space that opens onto the tread surface and is delimited by two main lateral faces connected by a bottom face, and having a width W defined by the mean distance between the two lateral faces and a depth D defined by the maximum radial distance between the tread surface and the bottom face,
at least one groove, which is a major groove, having a width W at least equal to 1 mm and a depth D at least equal to 4 mm,
the tire also comprising a crown reinforcement, radially on the inside of the tread, comprising at least one layer of reinforcing elements, denoted crown layer,
the at least one layer of reinforcing elements extending radially from a radially inner surface (RIS) to a radially outer surface (ROS),
the radially outermost crown layer comprising at least one undulation,
the at least one undulation in the radially outermost crown layer being such that the radially outermost crown layer portion of the undulation is radially on the outside of the points of said radially outermost crown layer that are vertically beneath the centre of the bottom face of the major groove closest to said undulation,
the at least one undulation in the radially outermost crown layer being such that, over at least 10% of the radially outer surface (ROS) of said crown layer, the radial distance (du) between the radially outer surface (ROS) of the radially outermost crown layer and the tread surface is at least 1.5 mm less than the radial distance (dc) between the radially outer surface (ROS) of the radially outermost crown layer and the tread surface, which is the distance vertically beneath the centre of the bottom face of the major groove closest to said undulation,
the minimum radial distance (du) between the radially outer surface (ROS) of the radially outermost crown layer of the crown reinforcement and the tread surface being at most equal to the depth D of the closest major groove plus 2 mm and at least equal to the depth D of the closest major groove minus 2 mm,
the part of the tread vertically above at least one undulation in the radially outermost crown layer comprising at least 30% of a rubber compound M, the dynamic shear modulus G* of which, measured at 40° C. at 10% peak-to-peak strain at 10 Hz, is at most equal to 3.25 MPa.

A tread generally comprises a large number of major grooves, which are or are not circumferential. A tread pattern of the tread could comprise a single major groove and a plurality of minor grooves and allow the invention to work.

A point on a layer of reinforcing elements belongs to the undulation in said crown layer if the radial distance between the point in question and the point on the same crown layer vertically beneath the radially innermost point of the bottom surface of the closest major groove is greater than 1 mm. If there is more than one closest major groove, the test for belonging to the undulation will be carried out taking into account the major groove that maximizes the radial distance in question. In order to calculate the radial distance, points of the reinforcing elements of the same kind will be considered: two points on the neutral axis, two radially outermost points of the reinforcing elements, two radially innermost points of the reinforcing elements.

The properties of the rubber compounds are measured on a viscosity analyser (Metravib VA4000) according to standard ASTM D 5992-96. The response of a sample of vulcanized composition, preferably a cylindrical test specimen with a thickness of 4 mm and a cross section of 400 mm², subjected to a simple alternating sinusoidal shear stress, at a frequency of 10 Hz, during a temperature sweep between 0° C. and 100° C., under a fixed stress of 0.7 MPa, is recorded. The dynamic shear moduli G* are measured at a given temperature, 40° C. at 10% peak-to-peak strain at 10 Hz, likewise according to standard ASTM D 5992-96. Using the same procedures, a shear modulus G* at 90° C. at 10 Hz and under a stress of 0.7 MPa is measured.

To improve certain performance aspects, for example dry grip, it is possible to use rubber compounds known to a person skilled in the art for particular usages, such as motor racing competitions, but these rubber compounds are not at all suitable for passenger vehicles, even sporty ones. This is because passenger vehicles have to comply with certain performance aspects, such as maximum rolling resistance values prescribed by environmental standards and minimum wear, endurance, grip and behaviour performance aspects. Specifically, these vehicles need to be able to be driven on public roads and under conditions of driving on wet ground and wet grip that are not those of a, closed, competition circuit for a very short time for an ultimately limited distance covered. Since the owners of these vehicles do not have a team for changing their tires if it rains and after an hour of driving when these tires are worn, there are design parameters for the tires according to the invention that are impossible to do away with, such as the presence of grooves in the tread and the capacity to cover thousands of kilometres with the tire, and thus a sufficient tread pattern depth. Preferably, the grooves in the tire constitute a void ratio in the tread in the new state that is at least equal to 10%. The void ratio is measured as the ratio of the volume of voids formed by all the cuts in the tread to the volume of the tread radially on the outside of the tread pattern bottom surface, voids included.

The rubber compounds in question exhibit low stiffness over temperature ranges that make them unusable for passenger vehicle tires according to the prior art, whether the wear performance is impaired by a low tread pattern height or by a normal tread pattern height that does not compensate for the low stiffness of the rubber compound, or whether the performance in terms of behaviour is excessively impaired on account of the combination of a normal tread pattern height and the low stiffness of the rubber compound. If this low stiffness is accompanied by high hysteresis, the performance in terms of rolling resistance will also be impaired. The use of these rubber compounds is therefore a problem per se.

The rubber compounds having a modulus G* at 40° C. dynamic shear modulus G*, measured at 40° C. at 10% peak-to-peak strain at 10 Hz, that is at most equal to 3.25 MPa, preferably at most equal to 3 MPa, preferably at most equal to 2.5 MPa, are for example highly negatively affected in terms of behaviour with a tread pattern height as exists for passenger vehicles.

The rubber compounds having a modulus G* at 90° C. dynamic shear modulus, measured at 90° C. at 10 Hz under a stress of 0.7 MPa, that is at most equal to 1 MPa, preferably at most equal to 0.75 MPa, preferably at most equal to 0.5 MPa, are highly negatively affected in terms of wear.

The invention, namely combining the undulations in the radially outermost crown layer with a low-stiffness rubber compound vertically above said undulation, makes it possible to use a low-stiffness rubber compound regardless of the associated property targeted. If the rubber compound of the tread has, combined with its low stiffness, excellent performance in terms of wear but high rolling resistance, the invention allows it to be used by reducing the volume of this rubber compound and the sheared height of this rubber compound in the tread. The invention also makes it possible to find an acceptable rolling resistance value. Similarly, for a high dry grip property combined with the low stiffness of the rubber compound, the deterioration in performance in terms of behaviour or wear can be resolved by the invention.

One of the properties that characterizes grip is the tan δ0 hysteresis value denoting the tan δ value measured at the temperature of 0° C. at 10 Hz and under a stress of 0.7 MPa. Thus, a preferred embodiment of the invention is that the rubber compound M has a tan δ0 value at least equal to 0.5, preferably at least equal to 0.6.

The undulations necessarily have to impact the radially outermost layer of reinforcing elements of the crown. The invention has an effect on the behaviour, the wear and the rolling resistance by reducing the volume of rubber compound in the tread vertically above the undulations. The other crown layers and the carcass reinforcement may or may not be undulated. In order to be perceptible, the undulations have to impact at least 10% of the surface of the radially outermost crown layer and the amplitude of the undulation that makes it possible to reduce the thickness of the rubber compound has to be at least equal to 1.5 mm.

Similarly, for optimal functioning, the undulation has to be positioned properly with respect to the tread pattern depth D. The minimum radial distance (du) between the radially outer surface (ROS) of the radially outermost crown layer (5) of the crown reinforcement (3) and the tread surface (21) is at most equal to the depth D of the closest major groove (24) plus 2 mm and at least equal to the depth D of the closest major groove (24) minus 2 mm. For a position that is radially too far towards the inside, the undulation will not make it possible to solve the problem, since it will not sufficiently reduce the height of rubber compound vertically above the undulation. If the undulation is positioned radially too far towards the outside, either wear will reveal the crown layers, which will pose an endurance problem, or a larger part of the tread could be thinned in order to improve rolling resistance and the solution would not be optimal.

Furthermore, passenger vehicle tires preferably have a tread pattern depth at least equal to 6 mm and at most equal to 10 mm. This depth is the maximum depth of the grooves on the tread. It is generally measured close to the equatorial plane of the tire. These values are a present-day compromise including aspects of wear, rolling resistance and behaviour among other performance aspects.

The undulations may or may not be identical for any meridian plane, depending on the tread pattern and the designer's choice. This solution goes against methods of tire manufacture in which the crown layers are laid on substantially cylindrical forms, the crown layers having, in the meridian plane, a regular curvature without a bending point, and have therefore been kept till now to solve problems associated with behaviour.

Undulating layers of reinforcing elements subjected to compressive loadings goes against the recommendations for combating the buckling of the structures. Specifically, creating a discontinuity in a radius of curvature amounts to creating additional stresses where buckling may occur. However, in the tire, the loadings are very highly localized, which means that part of the crown is in tension when another part is in compression, on a scale that is very much smaller than that of the undulations. Thus, the undulations made within the limits of the invention do not detract from the endurance of the tire.

These undulations make it possible to use a rubber compound of the tread that has low stiffness, namely in which the dynamic shear modulus G* at 40° C. at 10% peak-to-peak strain at 10 Hz, is at most equal to 3.25 MPa, at most equal to 3 MPa, preferably at most equal to 2.5 MPa, at least vertically above said undulations, no longer with the objective of improving rolling resistance and behaviour but for improving dry grip with improved behaviour and acceptable rolling resistance.

Depending on the desired performance aspects and the change thereof over time, it is possible for the rubber compound vertically above the undulation in the radially outermost crown layer to be entirely or partially in a rubber compound M of low stiffness with good dry grip. Preferably, the tread surface has this rubber compound in the new state.

The distance (du) is decreased by creating at least one undulation in the radially outermost crown layer, such that this undulation or undulated part of the crown layer is radially on the outside of the part of the crown layer that is vertically beneath the major groove closest to said undulation. It is not a matter of considering as being undulated a crown layer that is not undulated but that meets the criterion for reducing the distance du by decreasing the tread pattern depth in a given zone. This feature is furthermore known in particular for tires for passenger vehicles, in which the tread pattern depth is smaller on the axially outer edges of the tire, known as shoulders, than in the closest major grooves. In tires according to the prior art, in the part at the shoulders where the radial distance (du) decreases, the radially outermost crown layer is either at the same radius, or radially on the inside of the parts of the same crown layer that are vertically beneath the closest major groove.

The invention also works if one or more undulations are positioned in one or more parts of one or more shoulders of the tire.

The beneath-void distance (d1) will preferably be maintained in the major grooves. The minor grooves or the sipes are less sensitive to puncturing and attack by obstacles. They are protected by the rubber compound that gives them their technical characteristic of a groove with a shallow depth or a small width.

Vertically beneath the undulation in the radially outermost crown layer, all or part of the other crown layers may be undulated, as may the carcass layer depending on the structural stiffness desired for the crown. The radially outermost crown layer has to be undulated, and it may be the only undulated layer by using a padding rubber compound of suitable thickness disposed between the radially outermost crown layer and the radially adjacent crown layer, generally a working layer. However, two, three or all of the crown layers may be undulated in this way. The protective or hooping layers are optional in a tire and do not govern the advantage of the solution.

It appears that 10% of the tread surface with a rubber compound improved in terms of dry grip makes it possible to measure an improvement in performance such that it is enough for 10% of the radially outer surface of the radially outermost crown layer to be, in the part with the undulations, at a radial distance at least equal to 1.5 mm from the radially innermost points of said crown layer vertically beneath the closest major groove.

The amplitude of this undulation has to be at least equal to 1.5 mm in order to have significant effects on the scale of the tire. Thus, the difference between the radial distance (du) between the radially outer surface (ROS) of the radially outermost crown layer and the tread surface is at least 1.5 mm less than the radial distance (dc) between the radially outer surface (ROS) of the radially outermost crown layer and the tread surface, which is the distance vertically beneath the centre of the bottom face of the major groove closest to said undulation, over at least 10% of the radially outer surface (ROS) of the crown layer having one or more undulations.

In order to increase the stiffness of the crown and amplify the coupling between the undulations and the rubber compound M situated vertically beneath the undulation(s), a preferred solution is that a plurality of crown layers, the radially outermost crown layer and the crown layer radially adjacent thereto, or even all of the crown layers are undulated, in other words are at a distance from one another that is substantially constant across the entire width of the crown apart from the last three centimetres of their axial ends. This is because these axial ends sometimes receive decoupling rubber compounds.

The optimal solution takes into account the characteristics of the tire and possibly of the vehicle. Optimization may be effected depending on the directional nature of the tire, on the asymmetry thereof, on the camber angle of the vehicle.

Preferably, over at least 10%, preferably at least 20% and at most 85%, of the radially outer surface (ROS) of the radially outermost crown layer, the radial distance (du) between the radially outer surface (ROS) of the radially outermost crown layer and the tread surface is at least 1.5 mm, preferably 2 mm, less than the radial distance (dc) between the radially outer surface (ROS) of the radially outermost crown layer and the tread surface, which is the distance vertically beneath the centre of the bottom face of the major groove closest to said undulation. The design parameters that allow the adjustment of the performance aspects of grip, wear, rolling resistance and behaviour are:
the extent of the contact surface in the low-stiffness and high-grip rubber compound M and thus of the undulations in the radially outermost crown layer, in the knowledge that the void ratio of the tread pattern, which is rarely less than 10% or 15%, limits it to at most 85% (100%-15%). The greater the extent of the undulation, the more the use of the rubber compound is advantageous in terms of grip and has less of a negative effect in terms of rolling resistance. It may thus be possible to adjust the number of undulations and the percentage of low-stiffness and high-grip rubber compound M depending on the desired performance in terms of dry grip, rolling resistance and dynamic behaviour.
the amplitude of the undulation at least equal to 1.5 mm but limited to 5 mm on account of the radii of curvature to be imposed on the metallic working layers, which are rigid and therefore of low deformability, which makes it possible to adjust the shearing of the rubber compounds of the tread associated with the rolling resistance and dynamic behaviour.

A preferred solution is therefore that, over at least 10%, preferably at least 20% and at most 85%, of the radially outer surface (ROS) of the radially outermost crown layer, the radial distance (du) between the radially outer surface (ROS) of the radially outermost crown layer and the tread surface is at most 5 mm, preferably at most 3 mm, less than the radial distance (dc) between the radially outer surface (ROS) of the radially outermost crown layer and the tread surface, which is the distance vertically beneath the centre of the bottom face of the major groove closest to said undulation.

For optimum performance in terms of puncturing and attack of the crown, without penalizing the rolling resistance, the radial distance (d1) between the radially outer surface (ROS) of the radially outermost crown layer and the bottom face of the major grooves is at least equal to 1 mm and at most equal to 5 mm, preferably at least equal to 2 mm and at most equal to 4 mm. Below the lower limits, the tire may prove too sensitive to attack. Above the upper limits, the rolling resistance of the tire would be penalized.

It is advantageous for the tread, for example a major groove of the tread, to comprise at least one wear indicator, and for the minimum radial distance (du) between the radially outer surface (ROS) of the radially outermost layer of the crown reinforcement and the tread surface to be at least equal to the radial distance (df) between the tread surface and the radially outermost point of the wear indicator. Specifically, it is important for the user to be able to see that the tire is worn, using the wear indicator, and to be able to do so before the reinforcing elements of the radially outermost layer of the crown reinforcement begin to appear on the tread surface.

Advantageously, all parts of the tread and of the tread surface vertically above the undulations in the radially outermost crown layer (5) comprise at least 50% of the rubber compound M, preferably 75%, preferably 100%, in order to take the greatest advantage of the properties of the rubber compound M.

In a preferred embodiment of the invention, the part of the tread radially on the outside of the wear indicators is made up 100% of the rubber compound M, in order to take advantage of the properties of the rubber compound M until the tire is removed on account of wear.

Preferably, the depth D of a major groove (24) is at least equal to 6 mm and at most equal to 10 mm. Tread pattern depths of between 6 and 10 mm allow a good compromise between wearing and rolling resistance performance aspects in many passenger vehicle tires.

In instances in which the radially outermost layer of reinforcing elements of the crown reinforcement is a hooping layer, it is advantageous for the radially outermost layer of reinforcing elements of the crown reinforcement to comprise reinforcing elements made of textile, preferably of the aliphatic polyamide or aromatic polyamide type, of a type involving a combination of aliphatic polyamide and aromatic polyamide, of polyethylene terephthalate type or of rayon type, which are mutually parallel and form an angle B at most equal to 10°, in terms of absolute value, with the circumferential direction (XX′) of the tire.

One preferred solution is for at least one padding rubber compound having a radial thickness at least equal to 0.3 mm to be positioned vertically beneath any undulation in the radially outermost crown layer. The purpose of this is to allow the crown layers to undulate during manufacturing and curing. These padding rubber compounds may be present around the entire circumference of the tire or be disposed in certain portions of the tire, as required. It is possible to lay several padding rubber compounds vertically beneath the one or more undulations with different radius values having different properties depending on the tire specification sheet. If a single padding rubber compound is laid, its maximum thickness is approximately equal, for a given undulation, to the radial distance between the radially outermost point of the radially outer surface of the radially outermost crown layer at the undulation and the radially outer surface of the radially outermost crown layer vertically beneath the centre of the bottom face of the major groove closest to said undulation.

It is advantageous that, with the tread being formed from one or more rubber compounds, the padding rubber compound has a maximum dynamic loss tan δ1, measured at a temperature of 23° C. at 10 Hz, at most equal to and preferably 30% less than the maximum dynamic loss tan δ2 of the least hysteretic rubber compound of the tread and radially on the outside of the bottom surfaces of the major grooves, measured at a temperature of 23° C. and under a stress of 0.7 MPa at 10 Hz. For a padding rubber compound with the same hysteresis, the improvement in terms of rolling resistance is achieved only by the reduction in the shear stress loadings that this rubber compound experiences. Since the padding rubber compound does not experience the same stresses as the rubber material of which the tread is made, it is possible to modify its characteristics in order to further improve the rolling resistance. A 30% drop in hysteresis leads to a significantly greater improvement for the invention. The least hysteretic rubber compound of the tread is the rubber compound making up a portion of the tread radially on the outside of the tread pattern bottom surface, the maximum tan δ1 value of which, measured at a temperature of 23° C. and under a stress of 0.7 MPa at 10 Hz, is the lowest of all the rubber compounds of which a portion of the tread radially on the outside of the tread pattern bottom surface is made.

The response of a sample of cross-linked composition (cylindrical test specimen preferably with a thickness of 4 mm and a cross section of 400 mm2), subjected to a simple alternating sinusoidal shear stress, at a frequency of 10 Hz, at 23° C. according to standard ASTM D 5992-96, is recorded. A peak-to-peak strain amplitude sweep is carried out from 0.1 to 100% (outward cycle) and then from 100 to 0.1% (return cycle). The result that is made use of is the loss factor (tan(δ)). For the return cycle, the maximum value of tan(δ) observed (tan(δ) max at 23° C.) is indicated.

It is preferable for the crown reinforcement to consist of a hooping layer and a working reinforcement with two working layers having opposite angles, as in numerous current crown architectures.

### BRIEF DESCRIPTION OF THE DRAWINGS

The features and other advantages of the invention will be understood better with the aid of FIGS. 1 to 4, said figures not being drawn to scale but in a simplified manner so as to make it easier to understand the invention:

FIG. 1 is a part of a tire, in particular the architecture and tread thereof.

FIG. 2 shows a meridian section through the crown of a tire according to the invention and illustrates the different radial distances, du, d1, D, df, dc and a padding rubber compound (6) suitable for creating an undulation in the radially outermost crown layer, working layer or hooping layer, this undulation comprising, vertically above it, a low-stiffness rubber compound M.

FIG. 3 shows a meridian section through the crown of a tire according to the invention and illustrates the different radial distances, du, d1, D, df, dc and a padding rubber compound (6) suitable for creating an undulation in the crown reinforcement, the working layers and the hooping layer, this undulation comprising, vertically above it, and in 100% of the part of the tread radially on the outside of the wear indicators, a low-stiffness rubber compound M.

FIG. 4 (a, b, c, d) shows a portion of the crown of the tire delimited circumferentially and axially by major grooves (24) that likewise delimit an undulation (512) in the radially outermost crown layer (5) for a tire having a hooping layer (5) and two working layers (41, 42). It illustrates the possibility of arranging, vertically beneath the undulation (512), one or more padding rubber compounds (6), which may have different properties depending on the specific needs associated with their respective radial, axial and circumferential positions and also various distributions of the low-stiffness rubber compound M in the tread.

### DETAILED DESCRIPTION OF THE DRAWINGS

FIG. 1 shows a perspective view of a part of the crown of a tire. A Cartesian frame of reference (XX′, YY′, ZZ′) is associated with each meridian plane. The tire has a tread 2 intended to come into contact with the ground via a tread surface 21. Arranged in the tread are grooves 24 with a width W that possibly differs from one groove to another. The tire also comprises a crown reinforcement 3 comprising a working reinforcement 4 and in this case, for example, a hoop reinforcement 5. The working reinforcement comprises at least one working layer and in this case, for example, two working layers 41 and 42, each comprising mutually parallel reinforcing elements (411 for the crown layer 41). The radially outer surface (ROS) of the radially outermost working layer (41) is also shown.

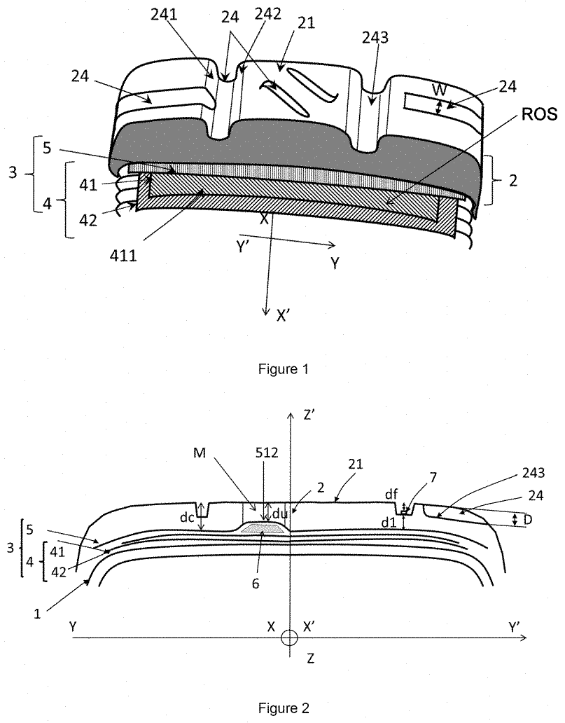

FIG. 2 schematically shows the meridian section through the crown of the tire according to the invention. It illustrates in particular the carcass layer 1, an undulation (512) of the radially outermost crown layer (5) and a padding rubber compound (6) positioned vertically therebeneath. FIG. 2 also illustrates the following radial distances:
D: the depth of a groove, which is the maximum radial distance between the tread surface (21) and the bottom face (243) of the groove,
dc: the radial distance between the radially outer surface (ROS) of the radially outermost crown layer (5) and the tread surface (21), which is the distance measured vertically beneath the radially innermost point of the bottom face (243) of the major groove (24) closest to said undulation (512),
du: the minimum radial distance (du) between the radially outer surface (ROS) of the radially outermost crown layer (5) of the reinforcement and the tread surface (21),
df: the radial distance between the tread surface (21) and the radially outermost point of the wear indicator (7),
d1: the minimum distance between the radially outer surface (ROS) of the radially outermost crown layer (5) and the bottom face (243) of the major grooves (24).

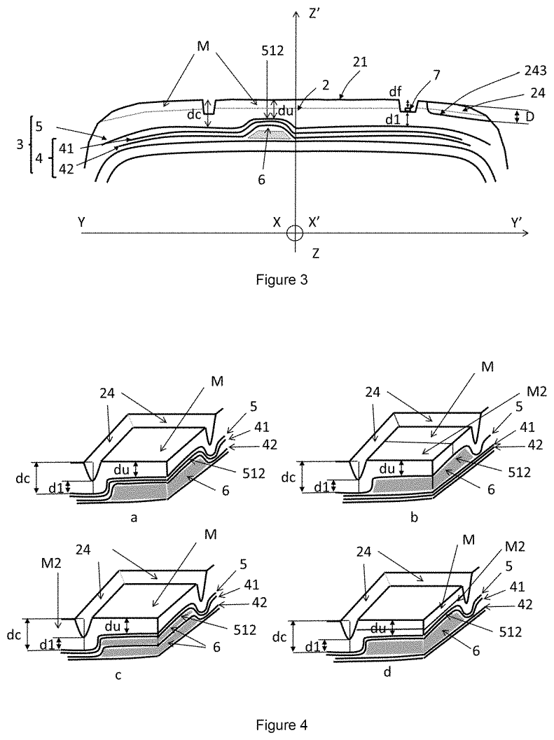

FIG. 3 schematically shows the meridian section through the crown of the tire according to the invention. It illustrates in particular an undulation in the crown reinforcement made up of two working layers (41 and 42) and the hooping layer (5), the radially outermost crown layer, and a padding rubber compound (6) disposed vertically beneath the undulation under the radially innermost working layer (42).

A meridian section through the tire is obtained by cutting the tire on two meridian planes. This section is used to determine the various radial distances, the centre of the bottom faces of the grooves and of the furrows.

FIG. 4a shows an undulation 512 in the crown reinforcement, the two working layers (41 and 42) and the hooping layer (5). The undulations are limited axially and circumferentially, at a tread pattern element. These tread pattern elements may repeat in the tread pattern of the tire with or without undulations vertically beneath them. The sum of the areas of the surfaces of the undulations has to at least represent 10% of the total surface area of the radially outermost crown layer in order for the effect to be advantageous. FIG. 4 abcd also shows how it is possible to obtain an undulation by laying a padding rubber compound 6 radially on the inside of the various layers of reinforcing elements of the crown reinforcement. In these tread pattern elements, the rubber compound M may be the only rubber compound of the tread, or of the tread pattern element or one of the rubber compounds. M2 in FIGS. 4b, 4c, 4d represents a second rubber compound, different from M, of the tread.

The invention was implemented on a tire A of size 305/30 ZR20 intended to equip a passenger vehicle. The depths D of the grooves in the tread pattern are between 5 mm at the shoulders and 7 mm at the equator, for widths W that vary between 4 and 15 mm. The crown reinforcement is made up of two working layers, the reinforcing elements of which make an angle of + or −38 with the circumferential direction, and of a textile hooping layer, the reinforcing elements of which make an angle of + or −3 with the circumferential direction. The radially outermost crown layer, the hooping layer 5, is undulated over 50% of its surface area. The undulations are made with the aid of padding rubber compounds radially on the inside of the radially innermost working layer, said padding rubber compounds being situated more specifically between the carcass layer and the radially innermost crown layer. The undulations have amplitudes of 2 mm, meaning that the radial distances (du) between the radially outer surface (ROS) of the radially outermost crown layer (5) and the tread surface at the undulations (512) are 2 mm less than the radial distances (dc) between the radially outer surface (ROS) of the radially outermost crown layer (5) and the tread surface (21), these being the distances vertically beneath the radially innermost point of the bottom face of the major grooves (24) closest to said undulations (512). The radial distance (d1) between the radially outer surface (ROS) of the radially outermost crown layer (5) and the bottom face (243) of the major grooves (24) is equal to 1.5 mm. The tread is made up of a single rubber compound CC1 having the following features:
G*, measured at 40° C. at 10% peak-to-peak strain at 10 Hz, is equal to 2.3 MPa,
a dynamic shear modulus G*, measured at 90° C. at 10 Hz and under a stress of 0.7 MPa, equal to 0.45 MPa,
tan δ, measured at a temperature of 0° C. at 10 Hz and under a stress of 0.7 MPa, is equal to 0.58.

Tires A were compared with tires B and C of the same size, having the same characteristics except that:
Tire B is such that its crown layers are not undulated and its tread consists of a single rubber compound CC2.
Tire C is such that its crown layers are not undulated and the tread consists of a single rubber compound CC1 similar to tire A.

The rubber compound CC2, which does not correspond to the invention, is a rubber compound suitable for use in the tread and has the following properties:
G*, measured at 40° C. at 10% peak-to-peak strain at 10 Hz, is equal to 3.3 MPa,
a dynamic shear modulus G*, measured at 90° C. at 10 Hz and under a stress of 0.7 MPa, equal to 1.05 MPa,
tan δ, measured at a temperature of 0° C. at 10 Hz and under a stress of 0.7 MPa, is equal to 0.48.

The padding rubber compound used to create the undulations in tire A has a dynamic loss tan δ1, measured at a temperature of 23° C. and under a stress of 0.7 MPa at 10 Hz, that is 60% less than that of the rubber compound CC1 of which the tread of A is made.

The performance aspects of the tire according to the invention can be seen in the following table in base 100. An evaluation above 100 means that the performance of the tire is better than that of the control. A better performance in terms of rolling resistance, and thus above 100, means that the rolling resistance of the tire is less than that of the control. Dry grip above 100 means that the time taken for a lap of the test circuit is less than that of the control tire.

TABLE I
performance of the invention

| | Rolling | Dry | | |
|---|---|---|---|---|
| | resistance | grip | Wear | Behaviour |
| A—invention | 100 | 102 | 100 | 100 |
| B | 100 | 100 | 100 | 100 |
| C | 92 | 101.5 | 90 | 90 |

The objective of the invention is to allow the use of “soft” or low-stiffness rubber compound in the tread. The prior art tires B, which do not have undulated crown layers or low-stiffness rubber compound in the tread, serve as control.

The use of low-stiffness rubber compound, as defined, in the tread on an architecture without undulation, visible in tire C, causes unacceptable degradations in all of the performance aspects of rolling resistance, wear and behaviour and only an improvement in dry grip, compared with the control tire B. Given the sporting use of the size and its high rolling resistance value, the deterioration in rolling resistance is such that the tire C is no longer acceptable in respect of environmental standards.

The invention, visible on tire A, not only makes it possible to remedy all of the deteriorations caused by the use of the low-stiffness rubber compound CC1 but surprisingly makes it possible to improve dry grip brought about a priori by the rubber compound CC1 by an additional 25% through the coupling between the architecture and the low-stiffness rubber compound.

The improvement of the invention in terms of rolling resistance was evaluated on a standard machine for measurements standardized in accordance with ISO 2850:2009.

The behaviour was evaluated by a measurement of the characteristic Dz of the Pacejka tire behaviour model well known to a person skilled in the art, at a pressure of 3 b, hot.

The tires were also fitted to a sports-type vehicle and tested on a winding circuit capable of generating significant transverse loadings. A professional driver, trained in assessing tires, compared tires A according to the invention with tires B and tires C according to the prior art and according to a rigorous testing process, under the same temperature conditions and ground running conditions, without knowing the characteristics of the tires being tested, repeating the measurement. The driver assigned scores to the tires. In all the tests performed, tires A according to the invention outclassed tires B and C in terms of vehicle behaviour, roadholding, on dry ground and in terms of grip.

Wear was evaluated in tests in which vehicles of the same type follow one another on a given circuit representing usage by customers. The vehicles were driven by professional drivers, trained in assessing tires and with the same type of driving style, according to a rigorous testing process, under the same temperature conditions and ground running conditions, without knowing the characteristics of the tires being tested, repeating the measurement. After each test day, the remaining tread pattern heights were measured. The wear given here corresponds to an improvement in wear after rolling that corresponds to 30% of the life of the tire.

1.-14. (canceled)

15. A tire for a passenger vehicle, comprising:
a tread intended to come into contact with the ground via a tread surface comprising grooves, at least one of which forms a space that opens onto the tread surface and is delimited by two main lateral faces connected by a bottom face, having a width W defined by the mean distance between the two lateral faces and a depth D defined by the maximum radial distance between the tread surface and the bottom face),
at least one groove, which is a major groove, having a width W at least equal to 1 mm and a depth D at least equal to 4 mm,
the tire also comprising a crown reinforcement, radially on the inside of the tread, comprising at least one layer of reinforcing elements, denoted crown layer,
the at least one layer of reinforcing elements extending radially from a radially inner surface (RIS) to a radially outer surface (ROS),
wherein the radially outermost crown layer comprises at least one undulation,
in that the at least one undulation in the radially outermost crown layer is such that the radially outermost crown layer portion of the undulation is radially on the outside of the points of said radially outermost crown layer that are vertically beneath the centre of the bottom face of the major groove closest to said undulation,
in that the at least one undulation in the radially outermost crown layer is such that, over at least 10% of the radially outer surface (ROS) of said crown layer, the radial distance (du) between the radially outer surface (ROS) of the radially outermost crown layer and the tread surface is at least 1.5 mm less than the radial distance (dc) between the radially outer surface (ROS) of the radially outermost crown layer and the tread surface, which is the distance vertically beneath the center of the bottom face (243) of the major groove closest to said undulation,
in that the minimum radial distance (du) between the radially outer surface (ROS) of the radially outermost crown layer of the crown reinforcement and the tread surface is at most equal to the depth D of the closest major groove plus 2 mm and at least equal to the depth D of the closest major groove minus 2 mm,
in that the part of the tread vertically above at least one undulation in the radially outermost crown layer comprises at least 30% of a rubber compound M, the dynamic shear modulus G* of which, measured at 40° C. at 10% peak-to-peak strain at 10 Hz, is at most equal to 3.25 MPa.

16. The tire according to claim 15, wherein the rubber compound M has a dynamic shear modulus G*, measured at 40° C. at 10% peak-to-peak strain at 10 Hz, that is at most equal to 3 MPa.

17. The tire according to claim 15, wherein the rubber compound M has a dynamic shear modulus G*, measured at 90° C. at 10 Hz and under a stress of 0.7 MPa, that is at most equal to 1 MPa.

18. The tire according to claim 15, wherein the rubber compound M has a tan δ0 value at least equal to 0.5, where tan δ0 denotes the tan δ value measured at a temperature of 0° C. at 10 Hz and under a stress of 0.7 MPa.

19. The tire according to claim 15, wherein, over at least 10%, and at most 85%, of the radially outer surface (ROS) of the radially outermost crown layer, the radial distance (du) between the radially outer surface (ROS) of the radially outermost crown layer and the tread surface is at least 1.5 mm less than the radial distance (dc) between the radially outer surface (ROS) of the radially outermost crown layer and the tread surface, which is the distance vertically beneath the center of the bottom face of the closest major groove.

20. The tire according to claim 15, wherein, over at least 10% and at most 85%, of the radially outer surface (ROS) of the radially outermost crown layer, the radial distance (du) between the radially outer surface (ROS) of the radially outermost crown layer and the tread surface is at most 5 mm less than the radial distance (dc) between the radially outer surface (ROS) of the radially outermost crown layer and the tread surface, which is the distance vertically beneath the center of the bottom face of the closest major groove.

21. The tire according to claim 15, wherein the radial distance (d1) between the radially outer surface (ROS) of the radially outermost crown layer and the bottom face of the major grooves is at least equal to 1 mm and at most equal to 5 mm and at most equal to 4 mm.

22. The tire according to claim 15, where at least one major groove of the tread comprises at least one wear indicator, wherein the minimum radial distance (du) between the radially outer surface (ROS) of the radially outermost crown layer of the crown reinforcement and the tread surface is at least equal to the radial distance (df) between the tread surface and the radially outermost point of the wear indicator.

23. The tire according to claim 15, wherein all parts of the tread and of the tread surface vertically above the undulations in the radially outermost crown layer comprise at least 50% of the rubber compound M, preferably 75%, preferably 100%.

24. The tire according to claim 15, and comprising at least one wear indicator, wherein the part of the tread radially on the outside of the wear indicators is made up 100% of the rubber compound M.

25. The tire according to claim 15, wherein the depth D of a major groove is at most equal to 10 mm.

26. The tire according to claim 15, wherein the void ratio of the tread is at least equal to 10%.

27. The tire according to claim 15, wherein the radially outermost crown layer of reinforcing elements of the crown reinforcement comprises reinforcing elements made of textile, preferably of the aliphatic polyamide or aromatic polyamide type, of a type involving a combination of aliphatic polyamide and aromatic polyamide, of polyethylene terephthalate type or of rayon type, which are mutually parallel and form an angle B at most equal to 10°, in terms of absolute value, with the circumferential direction (XX′) of the tire.

28. The tire according to claim 15, wherein at least one padding rubber compound having a radial thickness at least equal to 0.3 mm is positioned vertically beneath the undulation in the radially outermost crown layer.

29. The tire according to claim 15, wherein the padding rubber compound has a maximum dynamic loss tan δ1, measured at a temperature of 23° C. at 10 Hz, at most equal to and preferably 30% less than the maximum dynamic loss tan δ2 of the least hysteretic rubber compound of the tread (2) and radially on the outside of the bottom surfaces of the major grooves, measured at a temperature of 23° C. and under a stress of 0.7 MPa at 10 Hz.
